(19) United States
(12) Patent Application Publication
(10) Pub. No.: US 2017/0355196 A1
(43) Pub. Date: Dec. 14, 2017

(54) INK REPLENISH ADJUNCTIVE DEVICE AND INK REPLENISH DEVICE

(71) Applicant: Seiko Epson Corporation, Tokyo (JP)

(72) Inventors: Satoshi SHINADA, Shiojiri-shi (JP); Tadahiro MIZUTANI, Shiojiri-shi (JP); Taku ISHIZAWA, Matsumoto-shi (JP); Noriyuki FUKASAWA, Shiojiri-shi (JP); Tadashi WATANABE, Matsumoto-shi (JP); Ryoichi TANAKA, Shiojiri-shi (JP); Eiko YANAGIDA, Shiojiri-shi (JP)

(73) Assignee: Seiko Epson Corporation, Tokyo (JP)

(21) Appl. No.: 15/617,834

(22) Filed: Jun. 8, 2017

(30) Foreign Application Priority Data
Jun. 10, 2016 (JP) 2016-116155
Oct. 17, 2016 (JP) 2016-203332
Oct. 25, 2016 (JP) 2016-208864
Mar. 24, 2017 (JP) 2017-058630

(51) Int. Cl. B41J 2/175

(52) U.S. Cl. CPC B41J 2/17506; B41J 2/17596

(57) ABSTRACT

An ink replenish adjunctive device is used to replenish an ink to an ink tank that includes an ink inlet member having a flow path in an axial direction. The ink replenish adjunctive device includes a connection portion having an end that is connectable to the ink inlet member in a liquid-tight state, and an ink inflow portion that is configured to allow the ink flow toward the connection portion.

### CROSS REFERENCE TO RELATED APPLICATIONS

This application claims priority based on Japanese Patent Application No. 2016-116155 filed on Jun. 10, 2016, Japanese Patent Application No. 2016-203332 filed on Oct. 17, 2016, Japanese Patent Application No. 2016-208864 filed on Oct. 25, 2016 and Japanese Patent Application No. 2017-58630 filed on Mar. 24, 2017, the entire disclosures of which are hereby incorporated by reference.

### BACKGROUND

### Field

The present disclosure relates to an ink replenish adjunctive device which is used for replenishing an ink to the ink tank of a printer, and an ink replenish device which includes such an ink replenish adjunctive device.

### Related Art

An inkjet printer is provided with an ink tank for storing ink, and the ink is supplied from the ink tank to a print head. There are two types of ink tanks for the printers, a cartridge type and an ink replenish type. The ink tank of the cartridge type is replaced with a new ink tank when the remaining amount of ink becomes low. As for the ink tank of the ink replenish type, even when the remaining amount of ink becomes low, the ink tank is used without being replaced, and the ink is replenished from an ink replenish container, for example, an ink bottle.

JP2016-087844A discloses an ink bottle which is used for replenishing an ink to the ink tank of the ink replenish type. In this technology, a positioning protrusion is provided in the vicinity of the ink outlet port of the ink bottle. The protrusion is brought into contact with the end portion of the ink inlet port of the ink tank, and then the main body of the ink bottle is compressed to replenish ink.

In the technology described above, since a replenish operation is performed while the ink bottle is manually held, when the manual operation is erroneously performed, the ink may leak. Since the positioning protrusion of the ink bottle is brought into contact with the end portion of the ink inlet port of the ink tank, the locating protrusion may be smeared by the ink; this may contaminate the surrounding parts when the ink bottle is separated from the ink inlet port.

An object of the present disclosure is to provide an ink replenish device and an ink replenish adjunctive device which are unlikely to be contaminated with an ink. Another object of the present disclosure is to provide an ink replenish device and an ink replenish adjunctive device in which an ink replenish operation is easily performed.

### SUMMARY

The present disclosure is made to solve at least part of the foregoing problem, and may be realized as aspects or application examples below.

(1) According to an aspect of the present disclosure, there is provided an ink replenish adjunctive device for replenishing an ink to an ink tank that includes an ink inlet member having a flow path in an axial direction. The ink replenish adjunctive device comprises: a connection portion having an end that is connectable to the ink inlet member in a liquid-tight state; and an ink inflow portion that is configured to allow the ink flow toward the connection portion.

The ink replenish adjunctive device is possible to allow the ink to appropriately flow into the ink inlet member having the flow path in the axial direction to replenish the ink to the ink tank, while reducing the leakage of the ink.

(2) In the above aspect, the connection portion may be configured to be press-fitted to at least either one of an inside and an outside of the flow path in the ink inlet member.

In this configuration, it is possible to easily connect the connection portion to the ink inlet member.

(3) In the above aspect, the connection portion may include a valve which is configured to open in a state where the ink inlet member and the connection portion are connected together and which is configured to close in a state where the connection portion is removed from the ink inlet member.

In this configuration, it is possible to reduce contamination with the ink when removing the ink replenish adjunctive device from the ink inlet member.

(4) In the above aspect, the connection portion may include a grasp portion which is graspable when fitting the connection portion to the ink inlet member or removing the connection portion from the ink inlet member.

In this configuration, it is possible to fit and remove the connection portion while grasping the grasp portion, thereby reducing the possibility that a user touches the ink in the connection portion when fitting or removing the connection portion.

(5) In the above aspect, at least part of the ink inflow portion may be a bendable tube.

In this configuration, since the tube is bendable, the ink replenish container and the ink inflow portion are connectable together in a position or attitude in which the ink is unlikely to leak.

(6) In the above aspect, the ink replenish adjunctive device may further comprise a rigid ring which is more rigid than the tube, fitted to an outer circumference of the tube.

In this configuration, it is possible to reduce the blocking of the flow path of the ink due to bending of the tube.

(7) In the above aspect, the ink inflow portion may include a funnel-shaped portion.

In this configuration, even with the ink replenish container which is not connectable to the ink inlet member in a liquid-tight state, it is possible to replenish the ink to the ink tank by pouring the ink into the funnel-shaped portion.

(8) In the above aspect, the ink inflow portion may include an ink reservoir portion.

In this configuration, since the ink reservoir portion is able to temporarily store the ink, the ink is unlikely to leak to the surroundings even when replenishing a large amount of ink.

(9) According to another aspect of the present disclosure, there is provided an ink replenish device comprising an ink replenish adjunctive device of the above aspects; and an ink replenish container configured to supply the ink to the ink replenish adjunctive device.

With this ink replenish device, it is possible to use the ink replenish adjunctive device so as to easily replenish the ink from the ink replenish container.

(10) In the above aspect, the ink replenish container may include a deformable side wall.

In this configuration, it is possible to replenish the ink with a simple operation of, for example, deforming the ink replenish container. The ink replenish amount and the ink replenish speed are easily adjusted by the degree and speed of the deformation.

(11) In the above aspect, the ink replenish container may be connected to the ink inflow portion in a liquid-tight state, and the ink replenish container may include an ink inlet port for receiving supply of the ink.

In this configuration, it is possible to easily increase the amount of ink by connecting the ink replenish container through the ink replenish adjunctive device to the ink tank of the printer.

(12) In the above aspect, the ink tank may be placed within a printer, and the ink inflow portion of the ink replenish adjunctive device may include a tube, which is extended to an outside through a gap between a main body of the printer and a cover that covers the main body.

In this configuration, it is possible to replenish the ink to the ink tank without opening the cover of the printer, whereby the operation of replenishing the ink is easily performed. Moreover, it is unlikely that the interior of the printer is contaminated with the ink because the ink replenish container is connected to the tube outside the printer. Furthermore, even when the ink leaks from the ink replenish container, the user easily recognizes the leak and deals with it.

(13) In the above aspect, the ink replenish device may further comprise a rigid ring which is more rigid than the tube, fitted to an outer circumference of the tube.

In this configuration, even when the tube passes through the gap between the main body and the cover of the printer, the tube is unlikely to be blocked, and it is possible to smoothly replenish the ink to the ink tank.

(14) In the above aspect, the connection portion may include: a lid portion configured to cover a tip end of the ink inlet member so as to seal an outer surface of the ink inlet member; and a connection flow path portion configured to extend in a direction intersecting the axial direction of the ink inlet member when the lid portion covers the tip end of the ink inlet member, and the direction intersecting the axial direction coincides with a direction intersecting a direction in which the cover is opened and closed.

In this configuration, it is possible to make the ink inflow portion connected to the connection flow path portion to extend in the direction intersecting the direction in which the cover of the printer is opened and closed, whereby the ink inflow portion is easily arranged in the gap between the main body and the cover of the printer.

(15) In the above aspect, the connection portion may include: a plate-shaped member having a groove that is formed as the connection flow path portion; and a film configured to seal an opening of the groove.

In this configuration, it is possible to form the connection portion with a simple configuration.

(16) In the above aspect, the ink replenish container may include: an ink storage room configured to store the ink; an atmosphere communication path configured to make the ink storage room communicate with an atmosphere; and an air introduction path provided in a lower portion of the ink storage room in a state where the ink replenish container is used, and the air introduction path is configured to be connected to the atmosphere communication path so as to introduce air into the ink storage room.

In this configuration, since the air introduction path of the ink replenish container is provided in the lower portion of the ink storage room, it is possible to make the liquid surface level of the ink replenish container higher than the ink tank within the printer, whereby it is possible to increase the capacity of ink in the height direction while decreasing the installation area of the ink replenish container. By adjusting a difference in the height between an air introduction position (gas-liquid exchange position) to the ink storage room in the ink replenish container described above and the ink inlet member of the ink tank within the printer, it is possible to enhance the flexibility of an arrangement in which, for example, the ink replenish container is placed on the printer.

(17) In the above aspect, the ink replenish container may include a see-through wall through which an ink liquid surface within the ink replenish container is visually recognizable from the outside.

In this configuration, since the ink replenish container is installed outside the printer, it is possible to easily visually recognize the ink liquid surface as compared with a case where it needs to visually recognize an ink liquid surface in the ink tank within the printer.

The present disclosure may be realized in various aspects other than the ink replenish adjunctive device and the ink replenish device described above. For example, the present disclosure may be realized in aspects such as an ink replenish system which includes an ink tank and an ink replenish device.

### BRIEF DESCRIPTION OF DRAWINGS

FIG. 1 is a perspective view of a printer according to an embodiment;

FIG. 2 is a cross-sectional view of a main portion of an ink tank;

FIG. 3 is an illustrative diagram showing an ink replenish adjunctive device according to the embodiment;

FIG. 4 is an illustrative diagram of a state where the ink replenish adjunctive device of FIG. 3 is fitted;

FIG. 5 is an illustrative diagram showing an ink replenish adjunctive device according to another embodiment;

FIG. 6 is an illustrative diagram showing an example of a state where the ink replenish adjunctive device of FIG. 5 is used to replenish an ink;

FIG. 7 is an illustrative diagram showing an ink replenish adjunctive device according to further another embodiment;

FIG. 8 is an illustrative diagram showing an ink replenish adjunctive device according to another embodiment;

FIG. 9 is an illustrative diagram showing an ink replenish adjunctive device according to another embodiment;

FIG. 10 is an illustrative diagram showing the connection portion of an ink replenish adjunctive device according to another embodiment;

FIG. 11 is an illustrative diagram showing how the ink replenish adjunctive device including the connection portion of FIG. 10 is utilized to replenish the ink to the ink tank;

FIG. 12 is a cross-sectional view showing an example of the detailed structure of the ink replenish container of FIG. 11;

FIG. 13 is an illustrative diagram showing an example of a state where an ink replenish adjunctive device according to another embodiment is used to replenish the ink; and

FIG. 14 is an illustrative diagram showing the structure of the connection portion of FIG. 13.

### DESCRIPTION OF EMBODIMENTS

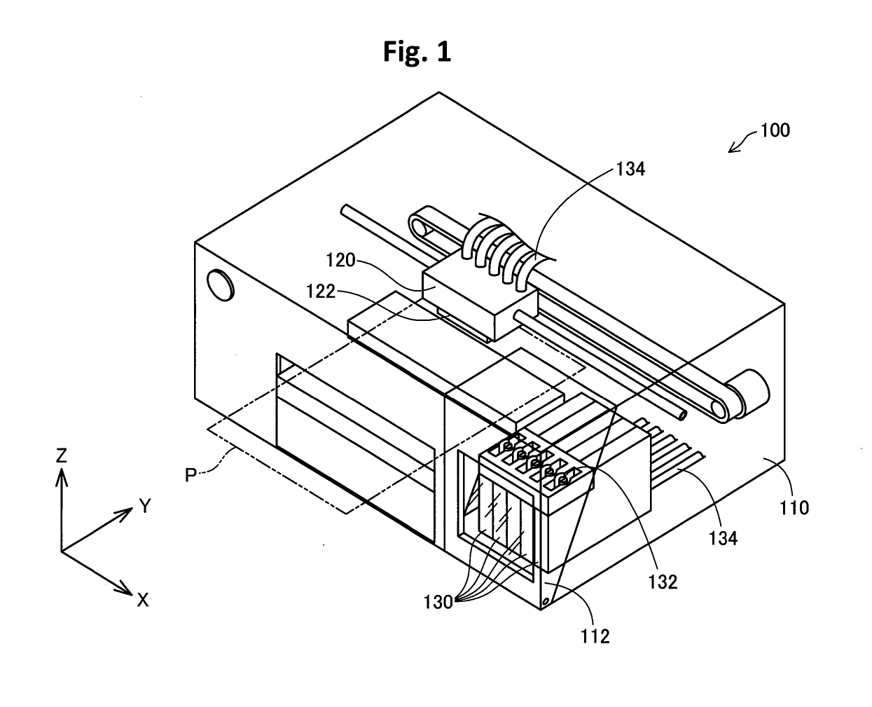

FIG. 1 is a perspective view of a printer 100 according to an embodiment. The printer 100 is an inkjet printer which discharges an ink onto a print medium P to perform printing. In FIG. 1, X, Y and Z axes which are perpendicular to each other are shown. The X axis corresponds to a width direction of the printer 100, the Y axis corresponds to a depth direction of the printer 100 and the Z axis corresponds to a height direction of the printer 100. The printer 100 is installed on a horizontal installation plane which is defined by the X direction and the Y direction.

The printer 100 includes a main body 110. The main body 110 is provided with a carriage 120 which is able to move in a main scanning direction (or X direction). On the lower surface of the carriage 120, there is installed a print head 122 which discharges the ink onto the print medium P. One end of the front surface of the main body 110 is provide with a cover 112 which is operable to be opened and closed. A plurality of ink tanks 130 are installed within the cover 112.

The ink tanks 130 are connected to the print head 122 of the carriage 120 by tubes 134. The inks within the ink tanks 130 are supplied through the tubes 134 to the print head 122. These ink tanks 130 are of the ink replenish type. On the upper surface of each of the ink tanks 130, there is protruded a cylindrical ink inlet member 132 used for replenishing the ink to the ink tank 130. The ink tanks 130 are stationary-type ink tanks that are not placed on the carriage 120. When the remaining amount of ink in each ink tank 130 becomes low, it is possible to open the cover 112 so as to replenish the ink from the ink inlet member 132 of the ink tank 130.

In the present specification, the term “replenish of the ink” means an operation of replenishing the ink to the ink tank 130 to increase the remaining amount of ink. However, it is not necessary to completely fill the ink tank 130 with the ink by the “replenish of the ink”. The “replenish of the ink” includes an operation of filling an empty ink tank 130 with the ink when the printer 100 is first used.

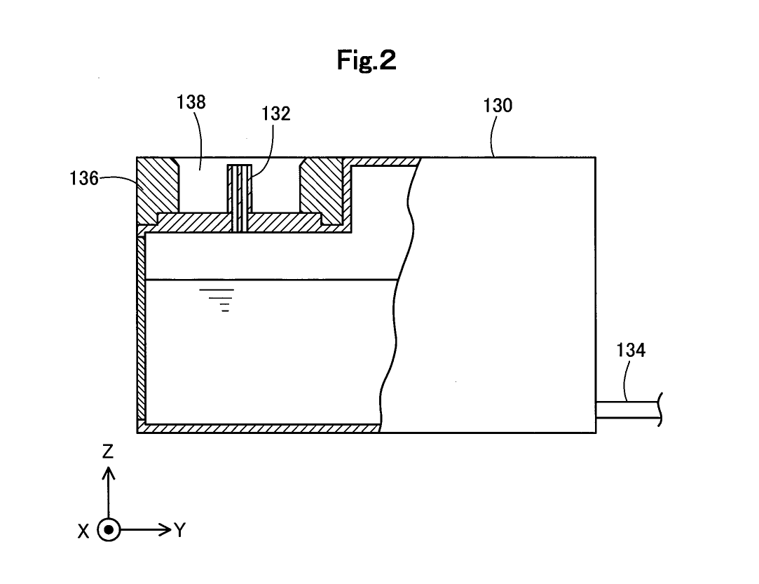

FIG. 2 is a cross-sectional view of a main portion of the ink tank 130. The ink inlet member 132 is protruded from the upper surface of the ink tank 130. Within the ink inlet member 132, flow paths are formed along the axial direction of the ink inlet member 132. Although in the example of FIG. 2, two flow paths are formed in the ink inlet member 132, only one flow path may be formed, or three or more flow paths may be formed. In part of the upper surface of the ink tank 130, an engagement adapter 136 is installed. The engagement adapter 136 is used when a specifically shaped ink replenish container (not shown) is used to replenish the ink to the ink tank 130; the engagement adapter 136 forms an engagement concave portion 138 which engages with the shape of the ink exit of the ink replenish container. However, the engagement adapter 136 may be omitted.

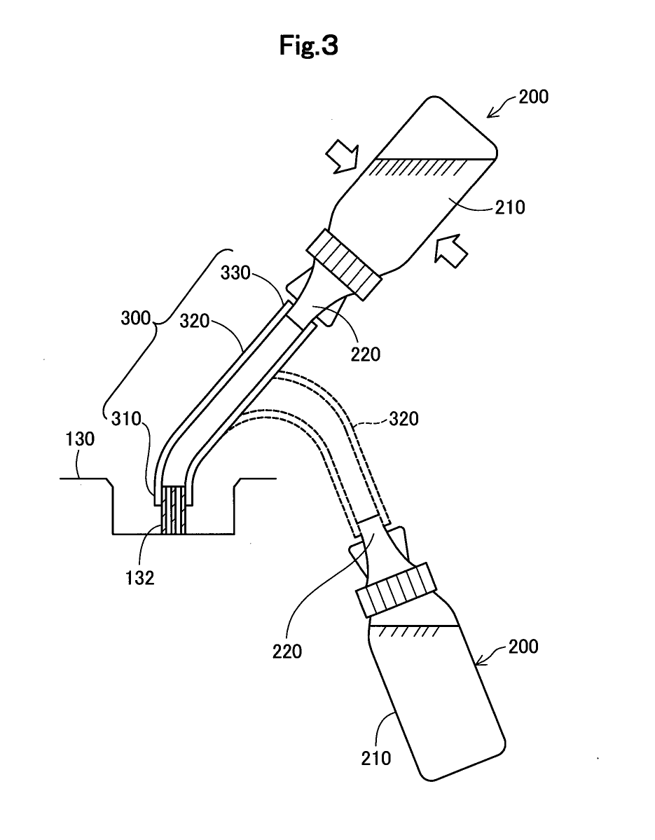

FIG. 3 is an illustrative diagram showing an ink replenish adjunctive device 300 according to the embodiment. The ink replenish adjunctive device 300 is utilized when an ink replenish container 200 is used to replenish the ink to the ink tank 130. The ink replenish adjunctive device 300 and the ink replenish container 200 form an ink replenish device as a whole.

The ink replenish container 200 includes a container main body 210 and an ink exit 220. The side wall of the container main body 210 is formed of a deformable member. As the deformable member, for example, a thermoplastic resin such as polyethylene or polypropylene may be utilized. As indicated by white arrows in FIG. 3, the ink replenish container 200 is of a “compression type” in which the container main body 210 is compressed to replenish the ink. The side wall of the container main body 210 is formed of an elastically deformable elastic member, and thus it is possible to replenish the ink with a simple operation of, for example, deforming the ink replenish container 200. The ink container main body 210 may be a container that includes a deformable side wall, such as a bag or a pouch, which is formed of a film. The ink replenish container 200 having the side wall formed of the deformable member is advantageous in that the ink replenish amount and the ink replenish speed are easily adjusted by the degree and speed of the deformation of the ink replenish container 200.

The entirety of the ink replenish adjunctive device 300 is formed of a tube. The ink replenish adjunctive device 300 includes a connection portion 310 which is to be connected to the ink inlet member 132 of the ink tank 130, an ink inflow portion 320 which is configured to allow the ink flow toward the connection portion 310, and a second connection portion 330 which is to be connected to the ink exit 220 of the ink replenish container 200. One end of the connection portion 310 is connectable to the ink inlet member 132 in a liquid-tight state. The connection portion 310 is press-fitted to the outside of the flow paths of the ink inlet member 132. The ink replenish adjunctive device 300 may be formed of, for example, a thermoplastic resin such as polyethylene or polypropylene. The same is true for the other ink replenish adjunctive devices which will be described later.

When the ink replenish adjunctive device 300 is used to connect the ink exit 220 of the ink replenish container 200 to the ink inlet member 132 of the ink tank 130, the ink inflow portion 320 of the ink replenish adjunctive device 300 is brought into a state where the ink inflow portion 320 is greatly bent as indicated by broken lines in FIG. 3. This is intended to prevent the ink from leaking to the outside from the ink exit 220 of the ink replenish container 200. Hence, at least part of the ink inflow portion 320 is preferably formed of a bendable material. For example, part or the whole of the tube forming the ink replenish adjunctive device 300 may be formed of a flexible elastic member. Alternatively, part or the whole of the ink inflow portion 320 may be formed of a bellows-shaped pipe line.

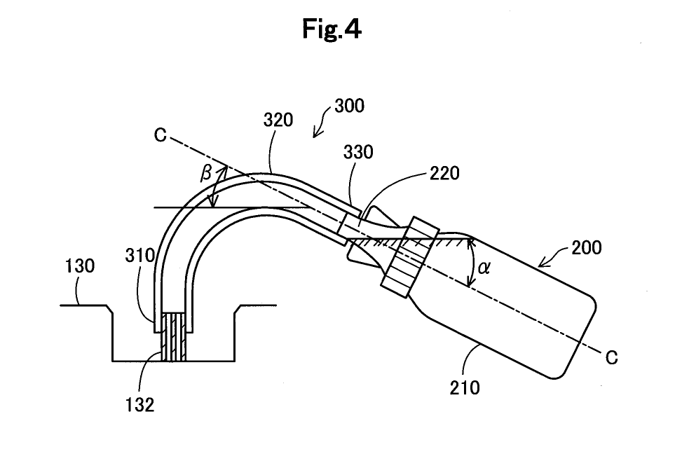

FIG. 4 is an illustrative diagram more specifically illustrating a state for fitting the ink replenish adjunctive device 300. In this state, the ink inflow portion 320 of the ink replenish adjunctive device 300 is bent, and the ink exit 220 of the ink replenish container 200 is directed obliquely upward. An angle α shown in FIG. 4 is an angle which is formed by the liquid surface and a center axis C of the ink replenish container 200 when the ink replenish container 200 is inclined as much as possible on condition that the ink does not leak to the outside. An angle β is the largest angle at which the second connection portion 330 at the other end of the tube is bendable downward from a horizontal plane in a state where the connection portion 310 of the tube serving as the ink replenish adjunctive device 300 is connected to the ink inlet member 132. When α<β, it is possible to connect the ink replenish adjunctive device 300 to the ink replenish container 200 without the ink spilling from the ink replenish container 200, and thus the replenish of the ink is easily performed. As the angle α, a value in a state where the ink replenish container 200 is completely filled with the ink is preferably used. As described above, by forming at least part of the ink inflow portion 320 of a bendable tube, it is possible to connect the ink replenish container 200 and the ink inflow portion 320 together in a state or attitude in which the ink is unlikely to leak.

Although in FIG. 3, the ink is replenished in a state or attitude in which the ink exit 220 of the ink replenish container 200 is directed downward, the ink may be replenished in a state or attitude in which the ink exit 220 is directed upward as shown in FIG. 4. Even in this case, the ink will be replenished by compression of the container main body 210.

The use of the ink replenish adjunctive device 300 shown in FIG. 3 advantageously makes it possible to utilize, as the ink replenish container 200, a container of an arbitrary shape which does not have an engagement member that engages with the engagement concave portion 138 described with reference to FIG. 2. The use of the ink replenish adjunctive device 300 advantageously makes it possible to cause the ink to appropriately flow into the ink inlet member 132 which has the flow paths in the axial direction.

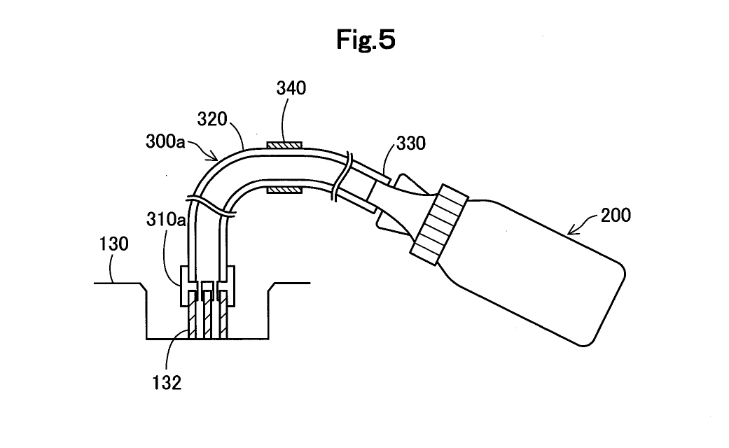

FIG. 5 is an illustrative diagram showing an ink replenish adjunctive device 300a according to another embodiment. The ink replenish adjunctive device 300a differs from the ink replenish adjunctive device 300 of FIG. 3 in the configuration of a connection portion 310a and the provision of a rigid ring 340 around the ink inflow portion 320.

The connection portion 310a is a separate member which is fitted to the tip end of the ink inflow portion 320 of the tube, and is formed in such a shape that the connection portion 310a is press-fitted to the flow paths of the ink inlet member 132 in the ink tank 130. In other words, the connection portion 310a is press-fitted to both the inside and outside of the flow paths of the ink inlet member 132. The use of the connection portion 310a advantageously makes it possible to more reliably connect the connection portion 310a to the ink inlet member 132.

In the example of FIG. 3 described previously, the connection portion 310 is press-fitted to the outside of the flow paths of the ink inlet member 132. In the example of FIG. 5, the connection portion 310a is press-fitted to both the inside and outside of the flow paths of the ink inlet member 132. Instead, the connection portion 310 may be formed so as to be press-fitted to the inside of the flow paths of the ink inlet member 132. In other words, the connection portion 310 is preferably formed so as to be press-fitted to at least either one of the inside and outside of the flow paths of the ink inlet member 132. By adopting any one of these structures, it is possible to simply connect the connection portion 310 to the ink inlet member 132. The feature of “the connection portion is configured to be press-fitted to at least either one of the inside and outside of the flow paths of the ink inlet member” is also common to the other embodiments which will be described later. However, the connection portion 310 and the ink inlet member 132 may be connected together by a method other than press-fitting, such as flange connection, for example.

The rigid ring 340 shown in FIG. 5 is formed of a member which is more rigid than the tube serving as the ink inflow portion 320. The term “more rigid” means that the Young's modulus is higher. The rigid ring 340 described above is fitted to the outer circumference of the tube, and thus it is possible to reduce a problem in which the tube is so bent as to block the flow path of the ink.

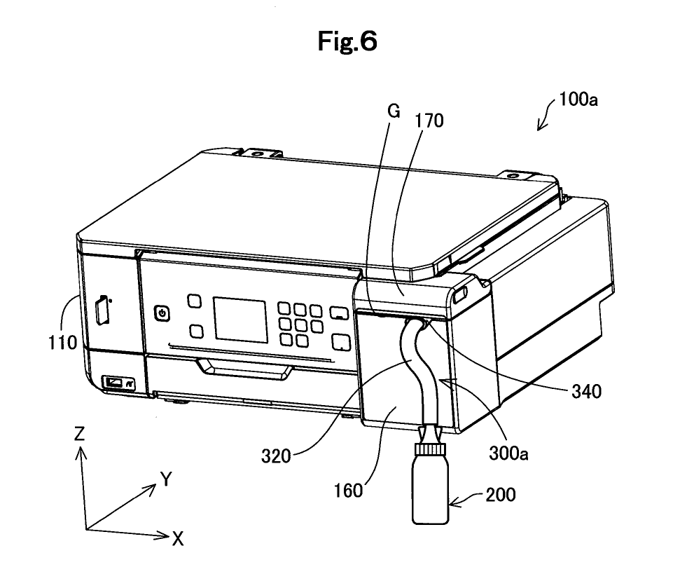

FIG. 6 is an illustrative diagram showing an example of a state where the ink replenish adjunctive device 300a shown in FIG. 5 is used to replenish the ink. A printer 100a shown in FIG. 6 is provided with an ink tank housing unit 160 which houses a plurality of ink tanks in one end of the front surface of the main body 110. The ink tank housing unit 160 includes, in an upper portion, a cover 170 which is operable to be opened and closed. The wall surface of the ink tank housing unit 160 below the cover 170 is part of the main body 110. In a state where the cover 170 is closed, a gap G is formed between the cover 170 and the main body 110. When the ink replenish adjunctive device 300a shown in FIG. 5 is used to replenish the ink, the tube-shaped ink inflow portion 320 preferably passes through the gap G between the cover 170 and the main body 110 to goes to the outside. In this way, it is possible to replenish the ink to the ink tank without opening the cover 170, and thus the operation of replenishing the ink is easily and advantageously performed. Moreover, the ink replenish container 200 is connectable to the tube-shaped ink replenish adjunctive device 300a at the outside of the printer 100a, and thus advantageously, it is unlikely that the interior of the printer 100a is contaminated with the ink. Furthermore, even when the ink leaks from the ink replenish container 200, a user is able to easily recognize and deal with it.

In the state shown in FIG. 6, the rigid ring 340 shown in FIG. 5 is arranged in the gap G between the cover 170 and the main body 110. By placing the rigid ring 340, which is more rigid than the tube-shaped ink inflow portion 320, in the gap G, it is unlikely that the tube-shaped ink inflow portion 320 is blocked even when the ink inflow portion 320 goes through the gap G between the main body 110 and the cover 170 in the printer 100a, whereby it is possible to smoothly replenish the ink to the ink tank.

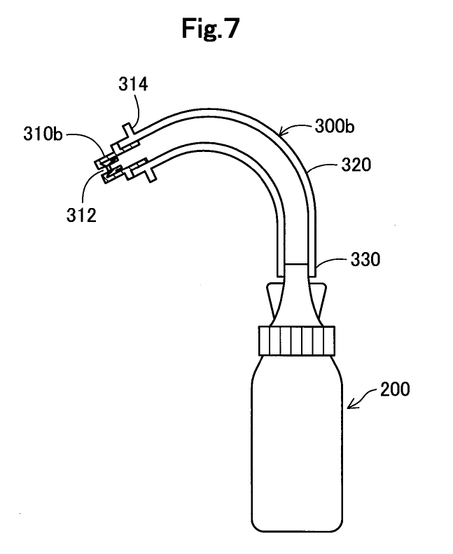

FIG. 7 is an illustrative diagram showing an ink replenish adjunctive device 300b according to another embodiment. The ink replenish adjunctive device 300b differs from the ink replenish adjunctive device 300 of FIG. 3 in that a connection portion 310b includes a valve 312 and a grasp portion 314. The valve 312 is configured to open in a state where the ink inlet member 132 (FIG. 2) of the ink tank 130 is connected to the connection portion 310b whereas the valve 312 is configured to close in a state where the connection portion 310b is removed from the ink inlet member 132. As the valve 312 described above, for example, a slit valve may be utilized. The valve 312 provided in the connection portion 310b advantageously makes it possible to reduce the contamination that may be caused by the leakage of the ink when the ink replenish adjunctive device 300b is removed from the ink inlet member 132.

The grasp portion 314 is a portion which is graspable when fitting the connection portion 310b to the ink inlet member 132 or removing the connection portion 310b from the ink inlet member 132. The grasp portion 314 is formed as a flange-shaped protrusion. The grasp portion 314 provided in the connection portion 310b advantageously makes it possible to fit and remove the connection portion 310b while holding the grasp portion 314, thereby reducing the possibility that the user is smeared with the ink around the connection portion 310b when the connection portion 310b is fitted or removed. In the embodiment shown in FIG. 7, one of the valve 312 and the grasp portion 314 may be omitted.

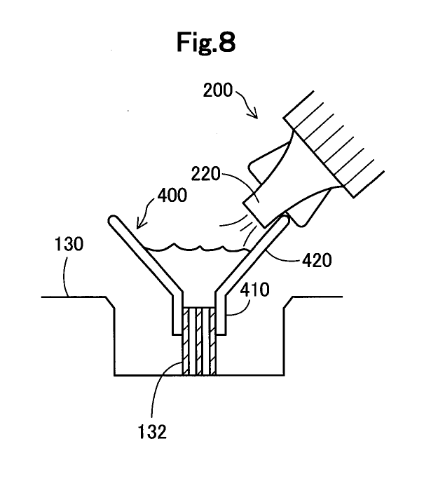

FIG. 8 is an illustrative diagram showing an ink replenish adjunctive device 400 according to another embodiment. The ink replenish adjunctive device 400 includes a connection portion 410 which is to be connected to the ink inlet member 132 of the ink tank 130, and an ink inflow portion 420 which causes the ink to flow toward the connection portion 410. The ink inflow portion 420 is formed as a funnel-shaped portion. The ink is replenished to the ink tank 130 in a state where, for example, the ink exit 220 of the ink replenish container 200 is in contact with the upper end of the ink inflow portion 420 of the funnel shape. The use of the ink replenish adjunctive device 400 advantageously makes it possible to replenish the ink to the ink tank 130 by pouring the ink into the funnel-shaped portion of the ink inflow portion 420, even if the ink replenish container is of a type which is not connectable to the ink inlet member 132 of the ink tank 130 in a liquid-tight state.

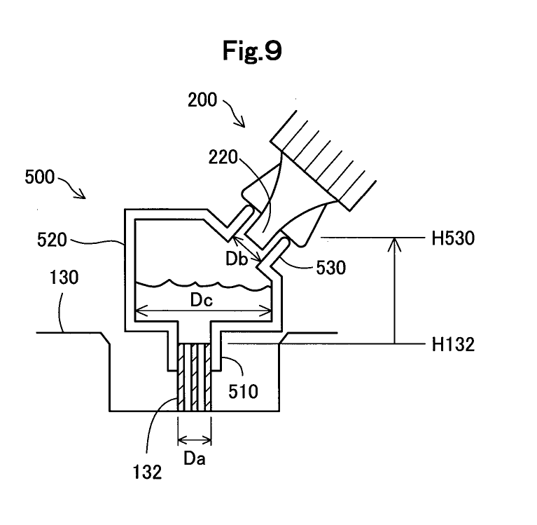

FIG. 9 is an illustrative diagram showing an ink replenish adjunctive device 500 according to another embodiment. The ink replenish adjunctive device 500 includes a connection portion 510 which is to be connected to the ink inlet member 132 of the ink tank 130, an ink inflow portion 520 which makes the ink flow toward the connection portion 510, and a second connection portion 530 which is to be connected to the ink exit 220 of the ink replenish container 200.

The ink inflow portion 520 is formed as an ink reservoir portion within which is able to store the ink. When the ink is replenished to the ink tank 130, the ink exit 220 of the ink replenish container 200 is inserted into the second connection portion 530, and the ink is poured and stored in the ink inflow portion 520. The lower end position H530 of the opening of the entrance of the second connection portion 530 is preferably higher than the upper end position H132 of the ink inlet member 132 in the ink tank 130. The ink in the ink inflow portion 520 flows, through the connection portion 510, into the ink inlet member 132 in the ink tank 130, and thus the ink is replenished into the ink tank 130. In the embodiment of FIG. 9, an inside diameter Db of the second connection portion 530 is preferably larger than an inside diameter Da of the connection portion 510. An inside diameter Dc of the ink inflow portion 520 serving as the ink reservoir portion is preferably larger than the inside diameters Da and Db of the connection portions 510 and 530. The use of the ink replenish adjunctive device 500 advantageously makes it possible to temporarily store the ink flowing into the ink reservoir portion, whereby the ink is unlikely to leak to the surroundings even when a large amount of ink is replenished.

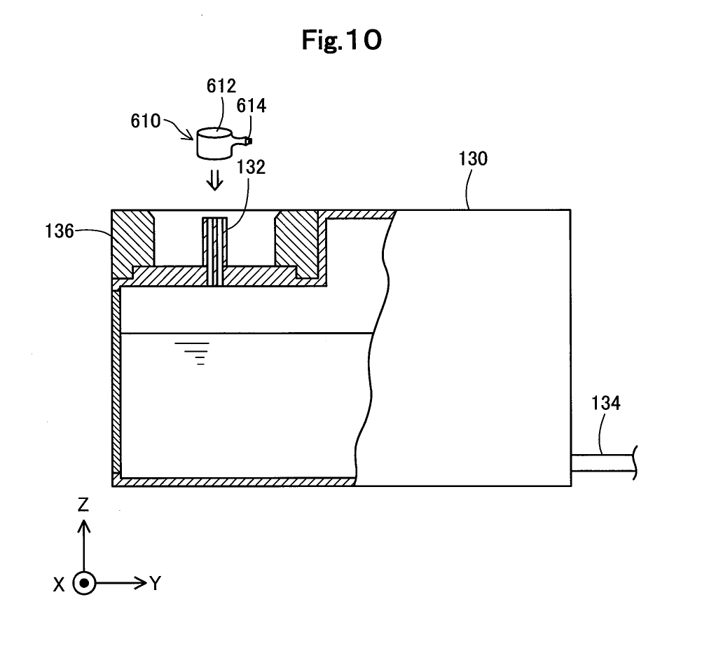

FIG. 10 is an illustrative diagram showing the connection portion 610 of an ink replenish adjunctive device according to another embodiment. The connection portion 610 is to be fitted to the upper end of the ink inlet member 132 in the ink tank 130. The connection portion 610 includes a lid portion 612 and a connection flow path portion 614. The lid portion 612 covers the tip end of the ink inlet member 132 so as to seal the outer surface of the ink inlet member 132. The connection flow path portion 614 is configured to extend in a direction intersecting the axial direction of the ink inlet member 132 when the lid portion 612 covers the tip end of the ink inlet member 132. In the example of FIG. 10, the axial direction of the ink inlet member 132 is extended in a vertical direction, and the direction in which the connection flow path portion 614 is extended in the horizontal direction. A tube is to be connected to the connection flow path portion 614.

When the ink replenish adjunctive device including the connection portion 610 shown in FIG. 10 is utilized in a printer 100a shown in FIG. 6, the direction in which the connection flow path portion 614 is extended preferably coincides with a direction which intersects the direction (Z direction in FIG. 6) in which the cover 170 of the printer 100a is opened and closed. In this way, the ink flow portion connected to the connection flow path portion 614 is configured so as to be extended in the direction which intersects the direction in which the cover 170 of the printer 100a is opened and closed, whereby the ink inflow portion is easily arranged in the gap G between the main body 110 and the cover 170 in the printer 100a.

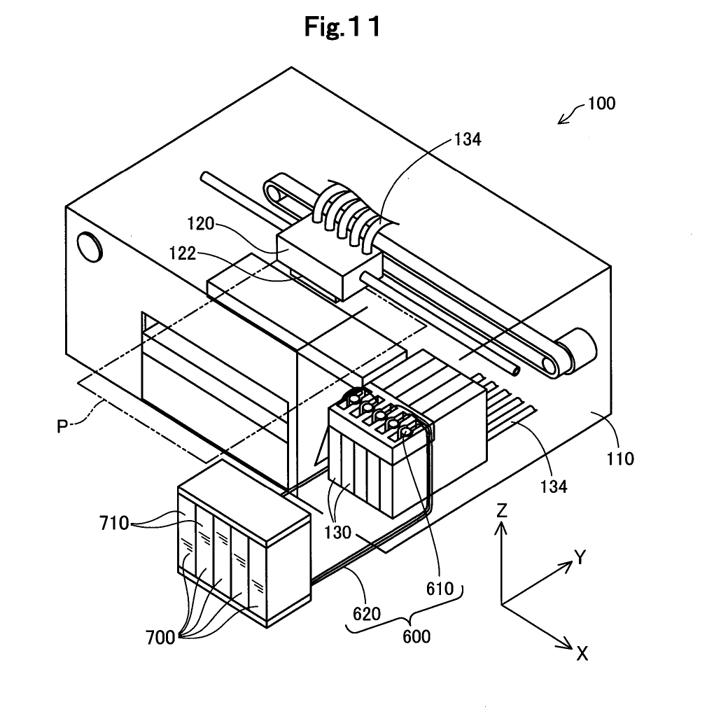

FIG. 11 shows how the ink replenish adjunctive device 600 including the connection portion 610 shown in FIG. 10 is utilized in the same printer 100 as shown in FIG. 1 so as to replenish the ink. Here, the connection portion 610 shown in FIG. 10 is connected to the ink inlet member 132 in each of the ink tanks 130 within the printer 100, and a tube-shaped ink inflow portion 620 is connected to the connection flow path portion 614 of the connection portion 610. The tube-shaped ink inflow portions 620 are further connected to ink replenish containers 700 which are installed outside the printer 100. The ink replenish container 700 includes a see-through wall 710 through which it is possible to visually recognize an ink liquid surface within the ink replenish container 700 from the outside. Since the ink replenish container 700 is installed outside the printer 100, it is easier to visually recognize the ink liquid surface, compared with a case where it needs to visually recognize an ink liquid surface in the ink tank 130 within the printer 100.

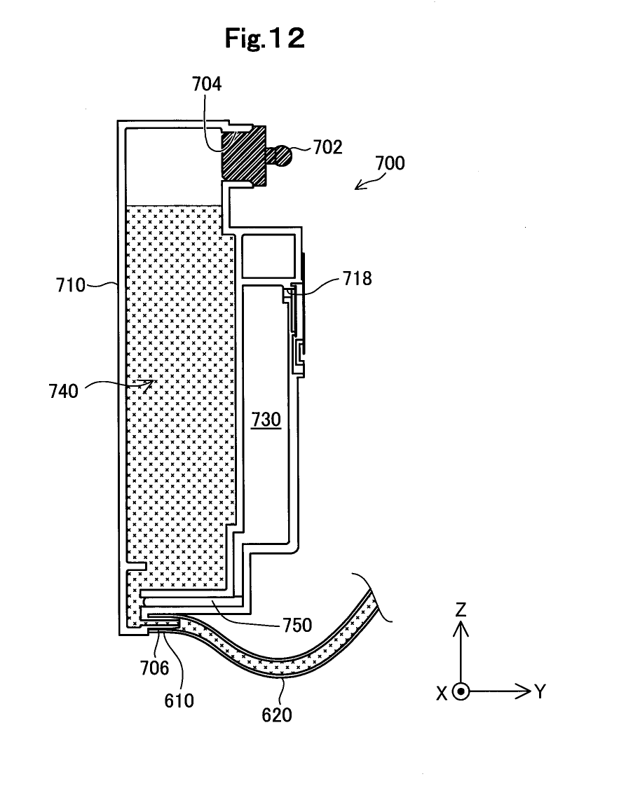

FIG. 12 is a cross-sectional view showing an example of the detailed structure of the ink replenish container 700 shown in FIG. 11. The ink replenish container 700 includes an atmosphere opening port 718, an atmosphere communication path 730, an ink storage room 740 configured to store the ink, and an air introduction path 750. The atmosphere communication path 730 is a flow path through which the ink storage room 740 is made to communicate with the atmosphere and which communicates with the atmosphere opening port 718. The air introduction path 750 is a flow path which is provided in a lower portion of the ink storage room 740 in a use state of the ink replenish container 700, and which is connected to the atmosphere communication path 730 so as to introduce air into the ink storage room 740.

In the lower end of the ink storage room 740, there is provided an ink exit 706 for connection to the connection portion 610 in the end portion of the tube-shaped ink inflow portion 620. Furthermore, an ink inlet port 704 is provided in the upper end of the ink storage room 740, and a stopper member 702 is fitted into the ink inlet port 704.

A position or attitude shown in FIG. 12 shows, as in FIG. 11, a position (referred to as a “usage position”) in a state where the ink is replenished to the ink tank 130 in the printer 100. In this state, it is possible to continuously replenish the ink from the ink replenish container 700 to the ink tank 130 even while the printer 100 is performing the printing operation.

When the remaining amount of ink in the ink replenish container 700 is decreased, the ink replenish container 700 is changed from the usage position of FIG. 12 to an injection position. The injection position is a position in which the ink inlet port 704 is opened vertically and upward. In the injection position, the user is possible to remove the stopper member 702 of the ink replenish container 700 from the ink inlet port 704 so as to introduce the ink from the ink inlet port 704.

The use of the ink replenish container 700 shown in FIG. 12 makes it possible to bring the liquid surface level of the ink replenish container 700 higher than the ink tank 130 within the printer 100 because the air introduction path 750 is provided in the lower portion of the ink storage room 740. Hence, it is possible to increase the capacity of ink in the height direction while the installation area of the ink replenish container 700 is decreased. By adjusting a difference in the height between an air introduction position (gas-liquid exchange position) to the ink storage room 740 in the ink replenish container 700 and the ink inlet member 132 of the ink tank 130 within the printer 100, it is possible to enhance the flexibility of an arrangement in which, for example, the ink replenish containers 700 are placed on the printer 100.

The ink replenish container 700 shown in FIG. 12 is to be connected to the ink inflow portion 620 in a liquid-tight state. The ink replenish container 700 includes the ink inlet port 704 for receiving the supply of the ink. The use of the ink replenish container 700 having such a structure makes it possible to easily increase the amount of ink by connecting the ink replenish container 700 through the ink replenish adjunctive device 600 to the ink tank 130 in the printer 100.

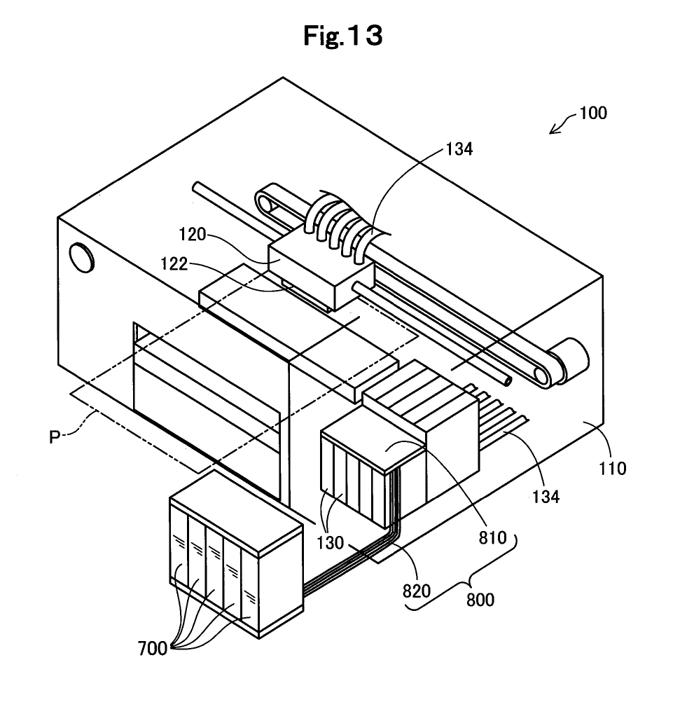

FIG. 13 is an illustrative diagram showing an example of a state where an ink replenish adjunctive device 800 according to another embodiment is used to replenish the ink. Here, a connection portion 810 is connected to the ink inlet members 132 of the ink tanks 130 within the printer 100, and tube-shaped ink inflow portions 820 are connected to the connection portion 810. The tube-shaped ink inflow portions 820 are further connected to the ink replenish containers 700 which are installed outside the printer 100. The ink replenish containers 700 are the same as shown in FIG. 11.

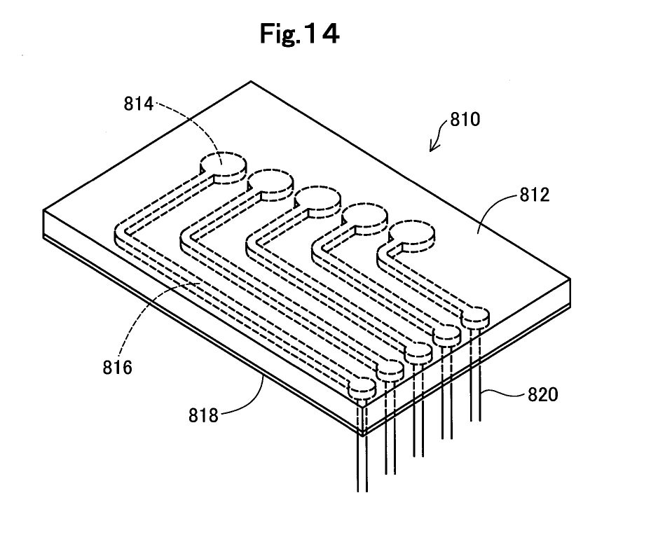

FIG. 14 is an illustrative diagram showing the structure of the connection portion 810 shown in FIG. 13. The connection portion 810 is formed of a plate-shaped member 812 in which grooves 816 are formed as connection flow path portions. One end of the grooves 816 are connected to the tube-shaped ink inflow portions 820. At the other end of the grooves 816, there are formed concave engagement portions 814 which are to engage with the upper ends of the ink inlet members 132 (FIG. 2) in the ink tanks 130. A film 818 which seals the openings of the grooves 816 is stuck to the lower surface of the plate-shaped member 812. The use of the connection portion 810 makes it possible, with a simple configuration, to form the connection portion 810 which is to be connected to the ink inlet member 132. In particular, with the structure shown in FIG. 14, a plurality of concave engagement portions 814 which are connectable to the ink inlet members 132 of all the ink tanks 130 in the printer 100 are formed in the one plate-shaped member 812, and thus it is possible to easily perform the connection to a plurality of ink tanks 130. When the connection portion 810 described above is used, the engagement adapter 136 shown in FIG. 2 is preferably removed. In this way, it is possible to easily fit the plate-shaped connection portion 810 to the ink inlet members 132 protruded from the ink tanks 130.

Variations:

The present disclosure is not limited to the embodiments described above and variations thereof, and may be practiced in various aspects without departing from the spirit thereof.

Variation 1:

Part of the members of the ink replenish adjunctive devices and the ink replenish containers according to the various embodiments described above may be arbitrarily omitted or changed. The structural characteristic portions in the ink replenish adjunctive devices according to the various embodiments may be arbitrarily applied to other embodiments. For example, the rigid ring 340 shown in FIG. 5 may be applied to the ink replenish adjunctive devices shown in FIGS. 3 and 7. The funnel-shaped portion in the embodiment shown in FIG. 8 may be applied to the shape of the bottom surface of the ink inflow portion 520 in the embodiment shown in FIG. 9.

Variation 2:

The present disclosure is not limited to an ink replenish device for replenishing an ink and an adjunctive device therefor, and may also be applied to a liquid replenish device which is utilized to replenish a liquid other than ink and an adjunctive device therefor.

What is claimed is:

1. An ink replenish adjunctive device for replenishing an ink to an ink tank that includes an ink inlet member having a flow path in an axial direction, comprising:
a connection portion having an end that is connectable to the ink inlet member in a liquid-tight state; and
an ink inflow portion that is configured to allow the ink flow toward the connection portion.

2. The ink replenish adjunctive device according to claim 1, wherein the connection portion is configured to be press-fitted to at least either one of an inside and an outside of the flow path in the ink inlet member.

3. The ink replenish adjunctive device according to claim 1, wherein the connection portion includes a valve which is configured to open in a state where the ink inlet member and the connection portion are connected together and which is configured to close in a state where the connection portion is removed from the ink inlet member.

4. The ink replenish adjunctive device according to claim 1, wherein the connection portion includes a grasp portion which is graspable when fitting the connection portion to the ink inlet member or removing the connection portion from the ink inlet member.

5. The ink replenish adjunctive device according to claim 1, wherein at least part of the ink inflow portion is a bendable tube.

6. The ink replenish adjunctive device according to claim 5, further comprising a rigid ring which is more rigid than the tube, fitted to an outer circumference of the tube.

7. The ink replenish adjunctive device according to claim 1, wherein the ink inflow portion includes a funnel-shaped portion.

8. The ink replenish adjunctive device according to claim 1, wherein the ink inflow portion includes an ink reservoir portion.

9. An ink replenish device comprising:
an ink replenish adjunctive device according to claim 1; and
an ink replenish container configured to supply the ink to the ink replenish adjunctive device.

10. The ink replenish device according to claim 9, wherein the ink replenish container includes a deformable side wall.

11. The ink replenish device according to claim 9, wherein the ink replenish container is connected to the ink inflow portion in a liquid-tight state, and the ink replenish container includes an ink inlet port for receiving supply of the ink.

12. The ink replenish device according to claim 9, wherein the ink tank is placed within a printer, and the ink inflow portion of the ink replenish adjunctive device includes a tube, which is extended to an outside through a gap between a main body of the printer and a cover that covers the main body.

13. The ink replenish device according to claim 12, further comprising a rigid ring which is more rigid than the tube, fitted to an outer circumference of the tube.

14. The ink replenish device according to claim 12, wherein the connection portion includes:
a lid portion configured to cover a tip end of the ink inlet member so as to seal an outer surface of the ink inlet member; and
a connection flow path portion configured to extend in a direction intersecting the axial direction of the ink inlet member when the lid portion covers the tip end of the ink inlet member, and the direction intersecting the axial direction coincides with a direction intersecting a direction in which the cover is opened and closed.

15. The ink replenish device according to claim 14, wherein the connection portion includes:
a plate-shaped member having a groove that is formed as the connection flow path portion; and
a film configured to seal an opening of the groove.

16. The ink replenish device according to claim 9, wherein the ink replenish container includes:
an ink storage room configured to store the ink;
an atmosphere communication path configured to make the ink storage room communicate with an atmosphere; and
an air introduction path provided in a lower portion of the ink storage room in a state where the ink replenish container is used, and the air introduction path is configured to be connected to the atmosphere communication path so as to introduce air into the ink storage room.

17. The ink replenish device according to claim 16, wherein the ink replenish container includes a see-through wall through which an ink liquid surface within the ink replenish container is visually recognizable from the outside.
